(19) United States
(12) Patent Application Publication
(10) Pub. No.: US 2016/0378763 A1
(43) Pub. Date: Dec. 29, 2016

(54) METHOD AND SYSTEM FOR ASSIGNING PUBLISHED SUBJECTS

(71) Applicant: Hermann Geupel, Munchen (DE)

(72) Inventor: Hermann Geupel, Munchen (DE)

(21) Appl. No.: 14/753,414

(22) Filed: Jun. 29, 2015

(51) Int. Cl. G06F 17/30

(52) U.S. Cl. CPC G06F 17/3053; G06F 17/30554; G06F 17/30061

(57) ABSTRACT

A 2- or 3-dimensional buzzword map that arranges buzzwords on the map depending on the frequency of combined appearance with other buzzwords on the map, measured in certain contexts, is provided in which each of the buzzwords is assigned to a 2- or 3-dimensional element which is arranged at a defined location in the 2- or 3-dimensional map. Respective positions of the elements or positional relations of the elements to each other reflect a relation between the contents of the respective buzzwords. The plurality of the elements associated to the pre-defined plurality of buzzwords is displayed on a display screen as 2- or 3-dimensional images, with the elements having a pre-defined extension in each of the dimensions of the map. The elements can be shaped as an ellipse, circle, rectangle, or square in a 2-dimensional map or as a ellipsoid, sphere, brick, or cube in a 3-dimensional map.

### BACKGROUND OF INVENTION

Field of Invention

The present invention relates to a method and a system for assigning a published subject to one of a plurality of pre-defined fields of knowledge, in particular for assigning a technical or product specification, respectively, to a technical field, using a plurality of pre-defined buzzwords to describe the subject. It also refers to a method and system for finding a published subject in one of a plurality of pre-defined fields of knowledge. The method and system of the present invention can be utilized in particular for technical and patent searches but is not limited to this utilization.

Description of Prior Art

When users search for certain information in the internet, they usually enter one or more buzzwords and receive a one-dimensional list of proposals by internet search engines or e-commerce vendors, whereas the hits are linearly structured from the best match on the top to the least match at the bottom. One-dimensional lists match to computer programs, whereas the human eye prefers to work two dimensionally. With regard to two-dimensionally displayed information mind maps and tag clouds are common. However, these two dimensional presentations of buzzwords lack priority-related structures as of the kind of linear structured lists.

Besides, users that consume information there are more and more users that contribute information in the internet (contributors). The online encyclopedia Wikipedia is one of the most famous examples. The contributors typically work for free. One can imagine that much more users could be motivated to contribute information, if they were paid. So-called crowdsourcing services try to leverage that potential. A crowdsourcing service may consist in preprocessing publications for enterprises by assigning them to topics, furtheron called buzzwords. The crowd that provide the service via the internet, furtheron called experts, need to be provided with tools that enable them to easily find and select buzzwords that apply for an analyzed publication.

One example of such an analysis of publications is the analysis of patent publications found within patent monitoring: Based on patent literature, being found within a monitored IPC class, today the company's patent specialists manually decide whether the publication is interesting for the company and sometimes further on assigns it to company internal buzzwords. The outsourcing of such manual, time consuming tasks often fails, because the search criteria that indicate whether patent publication is interesting for the company are regarded to be company specific. This sweeps off scale effects that might make outsourcing to external Experts profitable. If a way of using publications' assigned buzzwords across companies could be found, the work of assigning patent publications to buzzwords could be outsourced and thus organized in a much more efficient way.

Therefore, solutions to solve the above problems are required. The present invention provides such solution.

### SUMMARY OF THE INVENTION

It is an object of the present invention, to provide a method and system for supporting and efficiently managing search tasks, in particular in distributed knowledge and crowdsourcing environments.

It is a further object of the invention, to provide a basic configuration for providing an up-to-date knowledge classification scheme and visualizing the same both to contributors and users. More specifically, it is an object to provide a platform which facilitates dynamic updating of such schemes on the one hand and efficient browsing of the knowledge basis on the other.

The present invention solves the set task with a 2-dimensional (or 3-dimensional) buzzword map that arranges buzzwords on the map depending on the frequency of combined appearance with other buzzwords on the map, measured in certain contexts.

According to an aspect of the present invention, a method for assigning a published subject to a field of knowledge comprises that each of the buzzwords is assigned to a 2- or 3-dimensional element which is arranged at a defined location in a 2- or 3-dimensional map, wherein the respective positions of the elements or positional relations of the elements to each other reflect a relation between the contents of the respective buzzwords, and that the plurality of the elements associated to the pre-defined plurality of buzzwords is displayed on a display screen as a 2- or 3-dimensional image, that each of the elements has a pre-defined extension in each of the dimensions of the map, in particular being shaped as an ellipse, circle, rectangle, or square in a 2-dimensional map or as a ellipsoid, sphere, brick, or cube in a 3-dimensional map, and is adapted to be browsed for browsing within the n-dimensional map.

According to another aspect of the invention, a method for finding a published subject in a certain field of knowledge comprises, further to the features of the method mentioned above, that in the image of the map displayed on the display screen a single element or a sub-area or sub-space, respectively, containing plural elements is selected, and that subject or those subjects are displayed in a window on the display screen or on a separate display, to which the selected element or elements is/are associated.

According to a further aspect of the invention, a system for assigning a published subject to a field of knowledge or for finding a subject within a field of knowledge comprises a first database, wherein a set of fields of knowledge is stored; a second database, wherein a set of buzzwords is stored, each assigned to an element with a predetermined location in a 2- or 3-dimensional map, wherein positional relations of elements to each other reflect a contextual relation between the contents of the respective buzzwords; a third database storing a plurality of published subjects, wherein at least one buzzword is assigned to each of the subjects; a search entity for assigning a published subject loaded from the third database to a field of knowledge or for finding a published subject, based on a positional relation of at least one element to at least one other element in the 2- or 3-dimensional map, and the corresponding buzzword, in a field of knowledge; at least one display entity for displaying an image of the 2- or 3-dimensional map with the elements which are assigned to buzzwords, and at least one input entity or browser for providing inputs into the system, wherein the browser is adapted for browsing within the map displayed on the display.

In an embodiment of the invention, a list of all assigned published subjects is established, wherein the respective position of the most relevant buzzword in the 2- or 3-dimensional map or its positional relations to other relevant buzzwords are associated to the subject.

In a further embodiment, buzzwords of different levels of abstraction are used to describe the subject, wherein the respective level is marked-up in the associated element in the 2- or 3-dimensional map, in particular as a pre-defined color of the element or frame structure of a 2-dimensional element or shell structure of a 3-dimensional element.

In an embodiment of the invention, the extensions of the elements are correlated to the frequency of the appearance of the corresponding buzzword in the course of assigning a plurality of published subjects to the pre-defined fields of knowledge and building the 2- or 3-dimensional map.

In a still further embodiment of the invention, arranging the elements in the map starts with an initial set of buzzwords assigned to elements with pre-defined locations in the map, and the map is dynamically updated with each executed assignment of buzzwords to a subject, by adjusting the respective position or positional relations of the elements which are associated to the newly assigned buzzwords. In this regard, the dynamical updating is based on at least one of: a co-existence of buzzwords, a relation strength indicator indicating the strength of a relation between several buzzwords in a newly classified subject, and a confidence indicator indicating the level of confidence of an assignment of a buzzword to a newly classified subject.

In a further refined embodiment, the dynamical updating includes introducing new buzzwords into the assigning procedure and corresponding new elements are being introduced in the 2- or 3-dimensional map, wherein the positional relations of the new element to at least two existing elements are defined on the basis of a linguistic relation of the new buzzword to at least two existing buzzwords.

In an embodiment of the inventive system, the search entity comprises at least one of a search engine or human being.

In another embodiment of the system, the system comprises a browser for browsing within the map displayed on the display.

In a still further embodiment of the inventive system, the publication data base is implemented on a system server or as a freely accessible data base, and the search entities are adapted to access the system server database or public database, respectively.

In a still further embodiment of the invention, the system comprises a processing entity for dynamically updating an initial set of buzzwords assigned to elements with pre-defined locations in the map, the processing entity being connected to a plurality of data input entities which are adapted for specifying buzzwords or respective elements in the n-dimensional map.

In an embodiment of the inventive system the so far mentioned set of buzzwords is understood as set of primary buzzwords that is related to sets of secondary buzzwords. By choosing a primary buzzword displayed on a 2- or 3-dimensional map, one set or plural sets of secondary buzzwords displayed in other windows are automatically arranged, depending on the frequency of the assignment of the secondary buzzword to the chosen primary buzzword.

In a further embodiment of the inventive system, additionally to the chosen buzzword an observation bandwidth around the primary buzzword is being set, in order to trigger the display of associated secondary buzzwords in a separate window.

At least in certain embodiments, the present invention has at least one of the following effects/advantages:

The inventive buzzword map arranges buzzwords such, that buzzwords which usually occur together are visualized close to each other. The person that searches for certain buzzwords thus finds them with a higher probability in the neighborhood of already found ones.

The inventive map eases the outsourcing of the analysis of publications, e.g. to a crowdsourcing service. Considering the enormous amount of well-educated experts globally that are online with their smartphones, tablets and laptops and ready to casually earn some money by solving generic tasks as assigning publications to buzzwords, information may be globally structured in a new dimension.

The inventive map enables as well the reverse step of searching for publications matching to buzzwords or buzzword combinations

The inventive Buzzword map may be also applied for listing up products that are probably of interest for the visitor of an e-commerce website.

And more generally the Buzzword map can be applied for displaying any kind of search result.

### BRIEF DESCRIPTION OF THE DRAWINGS

FIGS. 1A-1D are schematic diagrams for illustrating the principle of building a 2-dimensional map of buzzword elements and of forming a group of such elements;

FIG. 2 a schematic diagram illustrating an initial configuration of a map formed from buzzword elements of different levels of abstraction;

FIGS. 3A and 3B a schematic diagram illustrating an exemplary image of a portion of a 2-dimension map in two different display modes;

FIG. 4 a schematic diagram illustrating a dynamically updated later version of the map according to FIG. 2; and

FIG. 5 a block diagram of an embodiment of the inventive system.

FIG. 6 an example of a primary buzzword map as IPC class map and related secondary buzzword list as list of publication descriptors

### DETAILED DESCRIPTION OF PREFERRED EMBODIMENTS

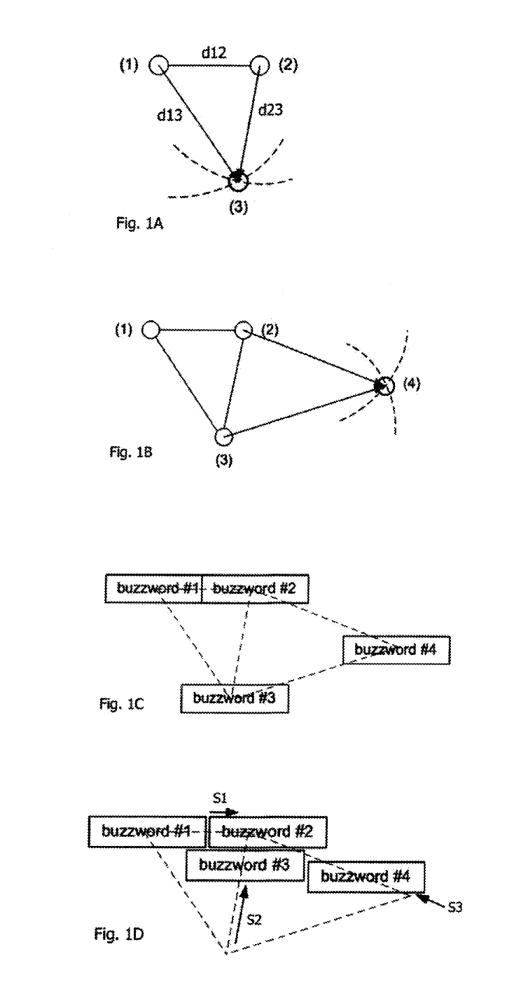

FIGS. 1A-1D schematically show how an exemplary 2-dimensional simple buzzword map is being established, starting with two hierarchically equal elements (1) and (2), arranged at a normalized distance d12.

FIG. 1A shows how a third element (3) is added, located in the map distances d13 to the element (1) and d23 to the element (3). The element (3) is positioned at the intersection of the circle with the radius d13 around element (1) and the circle with the radius d23 around the element (2). The distances d13, d23 can be defined by a processing entity which can be a human being or a computer software, for assessing the contextual or linguistic relationship between the buzzword corresponding to element (3) with respect to buzzword which is associated to element (1) and the buzzword which is associated to element (2). In a simple statistical, non-contextual approach, the relevant distances are based on (inversely proportional to) the frequency of the co-appearance of the respective buzzwords in the underlying classification scheme.

FIG. 1B shows a next step of adding a fourth element (4) to the map, based on the statistical or contextual relation of the corresponding buzzword to the buzzwords associated to elements (2) and (3), whereas no relationship exists or is considered with respect to the buzzword corresponding to element (1).

FIG. 1C shows the configuration of FIG. 1B in a different representation, i.e. displaying the elements (1)-(4) as rectangular tags of equal shape but with the positional relation (angles and distances) maintained as in FIG. 1B.

FIG. 1D shows an optional display configuration wherein the elements, maintaining their shapes as in FIG. 1C and along their connection lines, have been shifted to be arranged as close to each other as possible. This step can be considered as constituting a ‘tag cloud’ of related elements, to better visualize that they are quite closely related to each other, at the same time maintaining the relevant information which of the elements is closer or more distant to which other element.

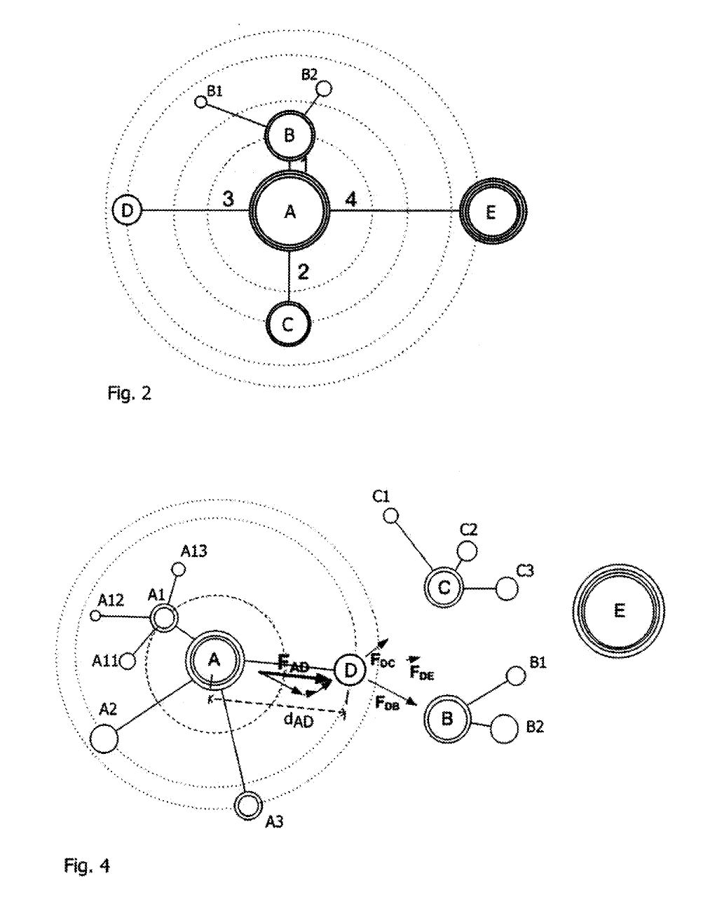

FIG. 2 shows an exemplary portion of a buzzword map according to the invention in an initial state, containing eight buzzwords A-H at different hierarchical levels or levels of abstraction, respectively. The figure shows how positional relations may be designed ab initio, starting with the buzzwords on the highest, most general detail level.

The buzzword A on the highest detail level, that by its meaning covers all buzzwords B-D on the map, is positioned in the center of the map. Buzzword B, among all buzzwords one level below buzzword A with the highest total frequency among the ‘relatives’ of A, is positioned vertically above buzzword A. B has two ‘satellites’ or ‘daughters’ B1, B2 with very low total frequency. Buzzword C, likewise one level below buzzword A with the second highest total frequency, is positioned vertically below buzzword A. Buzzword D, two levels below buzzword A with the third highest total frequency, is positioned to the left of buzzword A. Buzzword E, one level above buzzword A with almost the same total frequency as A, is positioned to the right of buzzword A at the largest distance to A. In this exemplary display configuration, the elements corresponding to the buzzwords are shown as circles or concentrical ring structures, respectively, wherein the number of rings corresponds to the level of abstraction of the respective buzzword, and the extension (diameter) of the elements corresponds to a predetermined relevance of the buzzword. This relevance is determined independently of the formation of the initial map but will be changed in the course of a subsequent dynamical updating of a map, see further below.

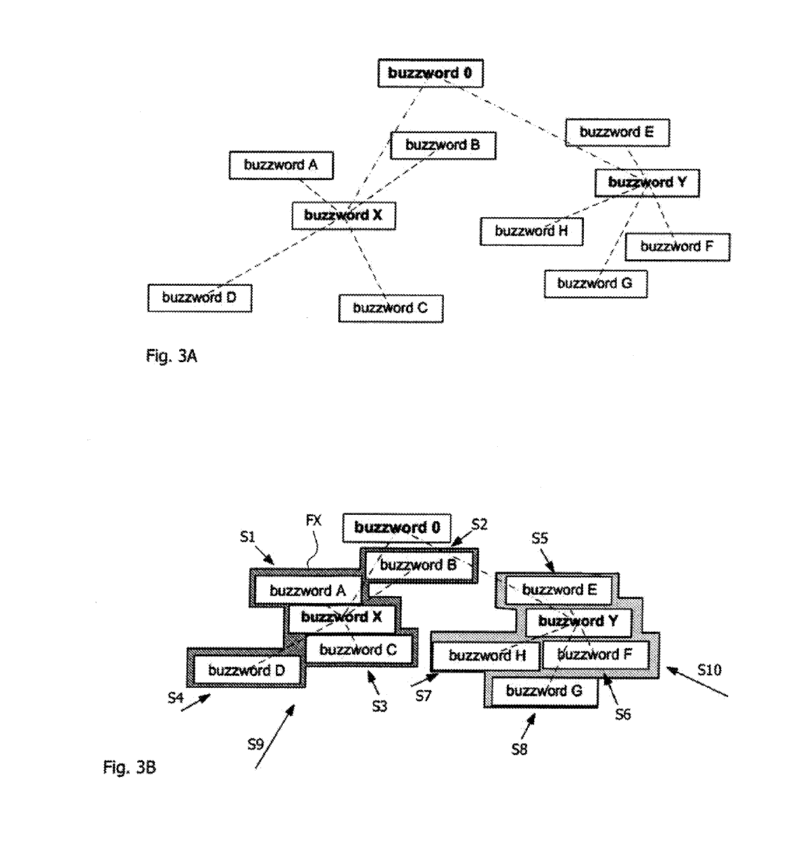

FIGS. 3A and 3B illustrate a procedure corresponding to the step between FIGS. 1C and 1D for two groups of related buzzwords, the first group including the buzzwords X and A-D and the second group including the buzzwords Y and E-H. In FIG. 3B the corresponding shifting steps are designated with S1-S10. FIG. 3B also shows how each of the element groups is surrounded by a common frame FX or FY respectively. In a color display, the frames FX and FY will typically be displayed in different colors.

In the exemplary embodiments of FIGS. 1C, 1D, 3A, and 3B the elements in the map are illustrated as rectangular tags. This offers, compared to circles (as in FIGS. 1A and 1B) the option to provide the elements with text, i.e. the relevant buzzword itself. Insofar, such rectangular, or similar, shaping of the tags contributes to establishing a map which is, to a large extent, self-explanatory and easy to handle even for users which do not frequently use the inventive system and are not fully familiar therewith.

Whereas in the above-mentioned figures all tags are of the same size and shown in black-and-white, in a practical implementation the sizes and/or colors of the tags can be different, depending on the relevance or frequency of appearance, respectively, of the underlying buzzwords.

FIG. 4 shows, based on the illustration of an initial configuration of the buzzword map in FIG. 2, an updated configuration which can be achieved after a large number of intermediate steps of classifying subjects in the relevant technical field. It can be seen in the figure that the position of the buzzwords B-E has dramatically changed with respect to their initial position, and likewise the positional relations between all buzzwords are totally different from the initial relations.

Furthermore, the figure shows that meanwhile from buzzword A ‘relatives’ have been derived, at different hierarchical levels, in the figure designated with numerals A1, A2, A3, and A11, A12, A13. Likewise, buzzword C has now ‘daughters’ C1, C2, and C3.

In the figure, the positional relation between buzzwords A and D is explained in more detail by indicating the relevant vector F_{AD} and the distance d_{AD} are indicated, as well as the vectors F_{DB} between the elements D and B, F_{DC} between the elements D and C, and F_{DE} between the elements D and E. The distance between elements A and D is dependent on the frequency of joint appearance of D and B and can be dependent on the total appearance of buzzword D, whereas the direction component of the vector F_{AD} depends on the positional relations of element D with respect to elements B, C, and E and can, in the simplest case, be derived from a vector addition of the respective vectors F_{DB}, F_{DC}, and F_{DE}.

What also can be derived from a comparison of FIGS. 4 and 2, is that during usage of the map in the meantime the relevance, i.e. frequency of appearance of the buzzwords has changed. This is clearly apparent for buzzwords A, the relevance of which has been decreased and E, the relevance of which has been heavily increased, as can be recognized from the size (diameter) of the corresponding elements in the map.

The above-referenced frequency of appearance of a buzzword can be understood as the number of times

a) the buzzword has been assigned to publications by offices, experts and/or regarded as relevant by a particular customer (individual point of view) or customers (overall point of view) or
b) the buzzword has been viewed, commented or purchased by a consumer (individual point of view) or consumers (overall point of view).

According to a further aspect, the direction between buzzwords A and D (wherein D can be considered as a ‘daughter’ of A) depends on the relative frequency of common appearance of D with each of the neighbor elements (buzzwords) B, C, and E. Depending on the context, for the exemplary relation between D and B the frequency h_{DB} can mean

c) the number of publications to which D and B have been both assigned by offices, experts and/or regarded as relevant by a customer (individual point of view) or customers (overall point of view) or

d) the number of consumers (overall point of view), which/or the number of times a particular consumer (individual point of view) have shown interest in both D and B, divided by the total frequency H_{B} of the neighbor buzzword B.

In a further embodiment of the invention the frequencies h and H may, depending on the context, be weighted by the level of importance, e.g. low, medium, high, that experts or customers assign to buzzwords, and the level of trust in the expert's ability to judge (context 1) or the degree of similarity of consumer profiles (context 2).

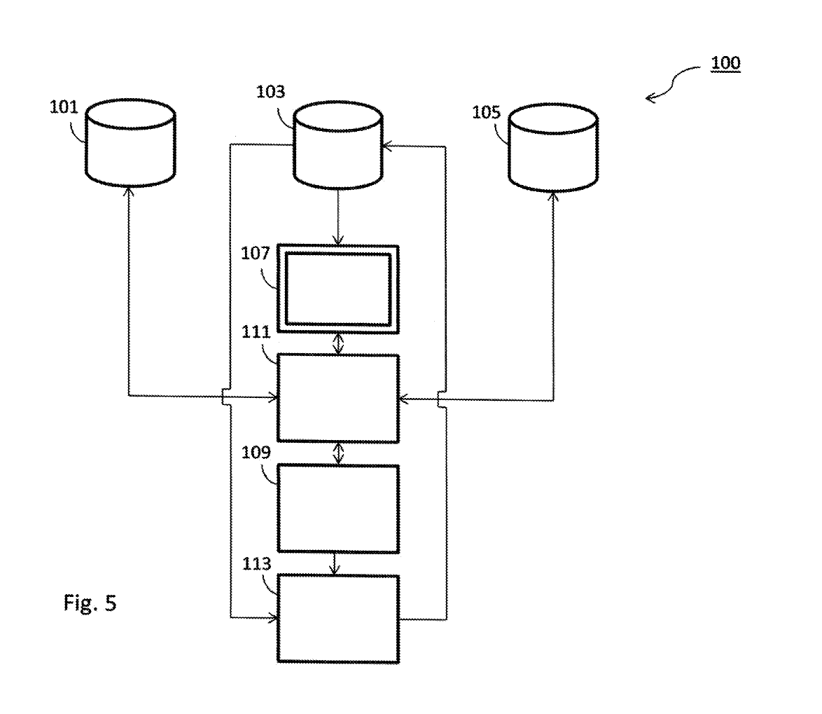

FIG. 5 illustrates an exemplary structure of the inventive system. The system 100 comprises a first database 101 for storing a set of fields of technical knowledge, a second database 103 for storing a set of buzzwords, and a third database 105 for storing a plurality of technical publications or patents, respectively. In the second database 103, each of the buzzwords is assigned to an element of a graphical display, the element having a predetermined location in a 2- or 3-dimensional map and a positional relation to other elements which reflects a contextual relation between the contents of the respective buzzwords. In a simpler, non-contextual implementation, a number or frequency of co-appearance of the corresponding buzzwords assigned to publications which have been searched using the system determines the positional relations of each element.

A display unit 107 is provided for displaying the 2- or 3-dimensional map with the elements assigned to the buzzwords, and a keyboard or touchpad function 109 serves for providing inputs into the system by a user (expert or customer), in particular for designating buzzwords to a publication or for selecting one or more elements in the map, to find the publication which has been classified by using the referenced buzzword(s). A search engine 111 is provided for assigning a publication in the third database 105 to a field of knowledge in the first database 101 or for finding the publication belonging to a certain element upon the user's input. A processing unit 113 is provided for dynamically updating an initial set of buzzwords and corresponding elements in the map displayed on a display 107 with new information which is input by the user on the keyboard or touchpad 109. The operation of the above-referenced system components is in line with the method described further above and will, therefore, not be repeated here.

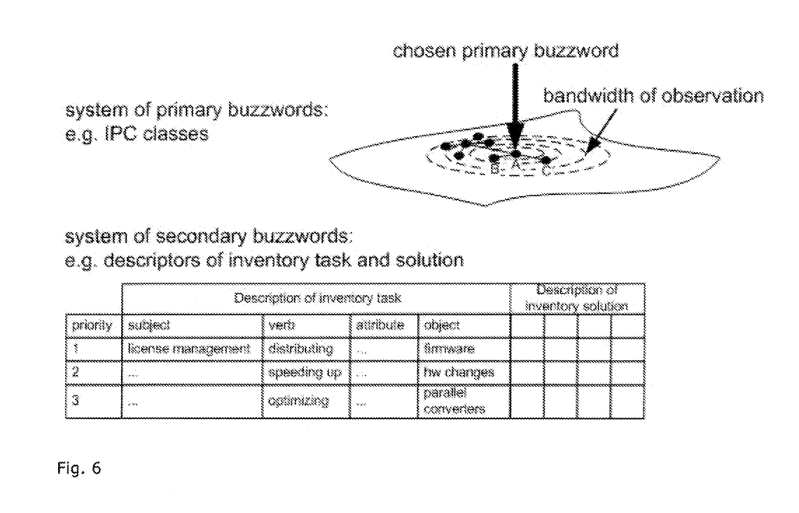

FIG. 6 shows how experts may summarize patent publications and users analyze the summary by using the inventory system. In this case the primary buzzwords equal International Patent Classification (IPC) classes and the chosen primary buzzword equals the main class of the patent publication, which needs to be summarized. Based on the recognized main class of the publication, the expert gets automatically secondary buzzwords displayed. These secondary buzzwords are descriptors, which may with a higher probability match with the content of the publication. One set of descriptors may describe the task and the other set of descriptors the solution, disclosed by the publication. Both sets of descriptors may consist of descriptor elements such as subject, verb, attribute and object. The descriptor elements which have been most frequently assigned to the publication's main IPC class and its neighbor classes are being ranked in a 1-dimensional list depending on the frequency of their appearance with the main class and its neighbors. The expert summarizes the publication's task and solution by best choosing pre-defined descriptor elements and, if necessary, creating new elements.

The user may search for publications which are assigned to certain descriptor elements. The result may be displayed as colored areas on the IPC class map (primary buzzword map).

While an embodiment of the present invention is illustrated and described, various modifications and improvements can be made by persons skilled in this art. The embodiment of the present invention is therefore described in an illustrative but not restrictive sense. It is intended that the present invention may not be limited to the particular forms as illustrated, and that all modifications which maintain the spirit and realm of the present invention are within the scope as defined in the appended claims.

We claim:

1. A method for assigning published subjects to one of a plurality of pre-defined fields of knowledge using a plurality of pre-defined buzzwords to describe the subject, comprising
assigning each of the buzzwords to a 2- or 3-dimensional element which is arranged at a defined location in a 2- or 3-dimensional map,
wherein the respective positions of the elements or positional relations of the elements to each other reflect a relation between the contents of the respective buzzwords, and
displaying the plurality of the elements associated to the pre-defined plurality of buzzwords on a display screen as a 2- or 3-dimensional image, assigning each of the elements a pre-defined extension in each of the dimensions of the map, with the elements being shaped as an ellipse, circle, rectangle, square, or other shape in the 2-dimensional map or as a ellipsoid, sphere, brick, cube or other 3-dimensional shape in the 3-dimensional map, and is adapted for browsing within the 2- or 3-dimensional map.

2. The method of claim 1, further comprising: establishing a list of all assigned published subjects, and associating the respective position of the most relevant buzzword in the 2- or 3-dimensional map or its positional relations to other relevant buzzwords to the subject.

3. The method of claim 1, further comprising: providing and using the buzzwords with different levels of abstraction to describe the subject, marking-up the respective level in the associated element in the 2- or 3-dimensional map as a pre-defined color of the element or frame structure of the 2-dimensional element or shell structure of the 3-dimensional element.

4. The method of claim 1, further comprising correlating the extensions of the elements are correlated to the frequency of the appearance of the corresponding buzzword in the course of assigning a plurality of published subjects to the pre-defined fields of knowledge and building the 2- or 3-dimensional map.

5. The method of claim 1, further comprising starting the arranging of the elements in the map using an initial set of the buzzwords that are assigned to the elements with pre-defined locations in the map, and dynamically updating the map with each executed assignment of buzzwords to a subject, by adjusting the respective position or positional relations of the elements which are associated to the newly assigned buzzwords.

6. The method of claim 5, wherein the dynamic updating is based on at least one of: a co-existence of the buzzwords, a relation strength indicator indicating a strength of a relation between several of the buzzwords in a newly classified subject, and a confidence indicator indicating a level of confidence of an assignment of one of the buzzwords to the newly classified subject.

7. The method of claim 5, wherein the dynamic updating further comprises introducing new buzzwords into the assigning procedure and introducing corresponding new elements in the 2- or 3-dimensional map, and the positional relations of the new element to at least two existing one of the elements are defined on the basis of a linguistic relation of the new buzzword to at least two existing ones of the buzzwords.

8. The method of claim 3, further comprising forming groups of neighbored elements around an element associated to a higher level buzzword based on distances of the respective elements to the element associated to the higher level buzzword and taking angular relations between the elements of the group into account.

9. The method of claim 8, wherein the elements of the group are arranged immediately adjacent to each other and are provided with a common display frame on the display screen.

10. The method of claim 1, wherein the method is for assigning a technical or product specification, respectively, to a technical field using the buzzwords.

11. A method for finding a published subject in one of a plurality of pre-defined fields of knowledge using buzzwords to describe the subject, comprising:
assigning each of the buzzwords to a 2- or 3-dimensional element which is arranged at a defined location in a 2- or 3-dimensional map, wherein the respective positions of the elements or positional relations of the elements to each other reflect a relation between the contents of the respective buzzwords,
displaying the plurality of the elements associated to the pre-defined plurality of buzzwords on a display screen as a 2- or 3-dimensional image, assigning each of the elements a pre-defined extension in each of the dimensions of the map, with the elements being shaped as an ellipse, circle, rectangle, square, or other shape in the 2-dimensional map or as a ellipsoid, sphere, brick, cube, or other 3-dimensional shape in the 3-dimensional map, and is adapted for browsing within the 2- or 3-dimensional map,
establishing a list of all assigned published subjects, associating a respective position in the 2- or 3-dimensional map of the most relevant ones of the buzzword or its positional relations to other relevant buzzwords to the subject, and
selecting in the image of the map displayed on the display screen a single element or a sub-area or sub-space, respectively, containing plural ones of the elements, and displaying that subject or those subjects in a window on the display screen or on a separate display, to which the selected element or elements is/are associated.

12. The method of claim 11, wherein the method is for finding a technical or product specification, respectively, in a technical field using the buzzwords.

13. A system for assigning a published subject to one of a plurality of pre-defined fields of knowledge or for finding a published subject in one of the fields of knowledge, using a plurality of pre-defined buzzwords to describe the subject, the system comprising:
a first database in which a set of fields of knowledge is stored;
a second database in which a set of buzzwords is stored, each assigned to an element with a predetermined location in a 2- or 3-dimensional map, wherein positional relations of the elements to each other reflect a contextual relation between contents of the respective buzzwords;
a third database in which a plurality of published subjects is stored, wherein at least one of the buzzwords is assigned to each of the subjects;
a search entity for assigning one of the published subject loaded from the third database to a field of knowledge or for finding a published subject, based on a positional relation of at least one of the elements to at least one other of the elements in the 2- or 3-dimensional map and the corresponding buzzword, in a field of knowledge;
at least one display for displaying an image of the 2- or 3-dimensional map with the elements which are assigned to buzzwords, and
at least one input device and/or browser for providing inputs into the system, wherein the browser is adapted for browsing within the map displayed on the display.

14. The system of claim 13, wherein the search entity comprises at least one of a search engine or human being.

15. The system of claim 13, wherein the third data base is implemented on a system server or as a freely accessible data base, and the search entities are adapted to access the system server database or public database, respectively.

16. The system of claim 13, further comprising a processing entity for at least one of providing and/or dynamically updating an initial set of the buzzwords assigned to the elements with pre-defined locations in the map, the processing entity being connected to the input device for specifying the buzzwords or the respective elements in the map.

17. The system of claim 16, wherein the processing entity comprises a statistical evaluation unit which is adapted for counting and processing respective numbers or frequencies of appearance of single one of the buzzwords or co-appearance of two or more of the buzzwords in the published subjects and for providing an output which determines or at least influences the positional relations of the elements in the 2- or 3-dimensional map.

18. The system of claim 13, where the system is for assigning a technical or product specification, respectively, to a technical field.
